(19) United States
(12) Patent Application Publication
(10) Pub. No.: US 2002/0147807 A1
(43) Pub. Date: Oct. 10, 2002

(54) DYNAMIC REDIRECTION

(76) Inventor: DOMENICO RAGUSEO, POMEZIA (IT)

Correspondence Address: IBM CORPORATION, PO BOX 12195, DEPT 9CCA, BLDG 002, RESEARCH TRIANGLE PARK, NC, 27709, US

(21) Appl. No.: 09/212,792

(22) Filed: Dec. 16, 1998

(30) Foreign Application Priority Data
Jan. 23, 1998 (GB) 9801484.8

(51) Int. Cl. G06F 15/16; G06F 15/173

(52) U.S. Cl. 709/224; 714/4; 709/227

(57) ABSTRACT

In a computer network having more than one available redirector or using more than one communication protocol, a method and a system for automatic recovering from a connection fault caused by a redirector or a communication protocol. The method monitors the connection link between the nodes and, upon detection of an error, switches to another redirector and to another communication protocol.

### TECHNICAL FIELD

The present invention relates to a method and system for automatically recovering from a protocol connection fault in a computer network.

### BACKGROUND OF THE INVENTION

The connection of computers to one each other forming a network has become one of the most important aspects of the information systems. The single computers are connected through a network not only for communication reasons, but often also to share common resources (e.g. a file system or a printer) among multiple users. As an example, in a local area network (LAN) a plurality of personal computer workstations are connected together and can use the same resources (hardware or software). Usually the communications among the individual workstations and the access to the common resources are controlled by one or more servers. A server can be a personal computer workstation or any other computer which makes resources available to all the network users through the individual workstations connected to the LAN. A typical example of server is a file server, i.e. a computer, having a local file system, which makes some of its files available to remote workstations. It is usual to dedicate a computer to the file server function in order to guarantee faster responses to remote access requests. Typically a file server has a large capacity storage disk whose files are available to all the users of the network. The files on the shared disks can be opened, read and written by remote users as if these files were local to the individual workstations. From the user's point of view the physical location of the files is not important.

The network needs an operating system which provides all the instructions for controlling the server operations and for managing the communications between a workstation and the server and among the individual workstations. Example of network operating systems are OS/2 Warp Server of International Business Machines Corp., Windows NT Server of Microsoft Corp. or NetWare of Novell Inc.

Since the single workstations connected to the network could be of different types and could have different operating systems installed, a common communication protocol is needed for exchanging messages and commands.

FIG. 1 shows an example of a simple Local Area Network having four personal computer workstations 103, 105, 107 and 109 and a file server 101 connected together. Each workstation has its own CPU and hard disk, but it can also use, in a shared way, the file system of the file server 101. The workstations 103, 105, 107 and 109 are called clients. A workstation or a computer in the LAN can contemporarily be a client and a server. Let's suppose the workstation 103 has a printer; if this printer is available for use to the other workstations 105, 107 and 109, the workstation 103 is also a print server for those workstations. To be able to access the remote resources from a workstation as if they were local, a “redirection mechanism”, or “redirector” is necessary. A redirector is software, installed on each client workstation and on each server, which enables the user of a workstation to use a remote resource in the same way of a local one.

Usually a name (e.g. a letter), similar to the names used for the local resources (e.g. the hard disk), is assigned by the redirector to this remote resource (e.g. a file in the file server). From this moment, the user can consider the remote resource exactly as any other local resources and he doesn't need to worry about the physical location of the resource.

There are different kinds of redirector commercially available, such as LAN Server and NFS of International Business Machines Corp., NetWare Server of Novell Inc. which is already included in the NetWare operating system, PC-NFS of Microsoft Corp., WebNFS of Sun Microsystems Inc. The main difference between one redirector and another is the different communication protocol used. LAN Server uses a protocol called NetBIOS, all the NFS products use TCP/IP while NetWare uses IPX. As mentioned above a redirector is a client-server application, so each redirector is composed of a client module and a server module. For example LAN Server comprises LAN Server (on the server) and LAN Requester (on the client workstations); NFS running on OS/2 comprises the module nfsd/portmap (on the server) and nfsctl (on the client workstations).

As an example, let's suppose that in the Local Area Network represented in FIG. 1 a computer A (101) owns a file system which can be accessed by the workstations B, C, D and E (103, 105, 107 and 109) of the LAN. A is called a server while B, C, D and E are the clients. If a user working on workstation B wishes to access a file on server A he needs to have the client module of a redirector installed (e.g. NFS using the communication protocol TCP/IP, which must be the same protocol used by server A). The user should issue the command

“mount x: A:d:\”

This means (according to the NFS rules) that a drive “d:” physically resident on server A is named “x:” and can be accessed by client B just using its logical name.

With a different redirector and communication protocol, the syntax of the command would have been different, but the concept would be the same. As an example, with the redirector LAN Requester, instead of the command “mount” as shown above, the command “net use” is used. With the redirector NetWare Server the command to issue would be “map”. Anyway the result would always be that the user of the client workstation can access a remote resource (in this case a file) simply by using a logical name, without worrying about the physical path to reach the remote resource.

In recent computer networks it is more and more usual to have more than one redirector and more than one protocol installed on the servers and the client workstations. This means that a resource could be accessed in more than one way, or even through different possible routes.

According to state of the art systems, if the communication between two network nodes fails for problems related to a determined communication protocol, a human intervention is needed and data and messages can be lost even if the connection between the two nodes could be done via a different route according to a different protocol.

It is an object of the present invention to provide a technique which alleviates the above drawbacks.

### SUMMARY OF THE INVENTION

According to the present invention we provide a computer network system connecting a plurality of nodes according to a plurality of available communication protocols, the system comprising:

means for establishing a communication between two nodes using a first of said plurality of communication protocols;

means for detecting a fault in the communication between said two nodes;

means for automatically re-establishing the communication between said two nodes using a second of said plurality of available communication protocols.

Further, according to present invention, we provide a method for automatic recovery from a connection fault in a computer network system, the computer network system connecting at least two of a plurality of nodes according to a first of a plurality of available communication protocols, the method comprising the steps of:

monitoring the connection between said two nodes;

upon detection of a fault in the connection between said two nodes re-establishing the communication between said two nodes using a second of said plurality of available protocols.

### BRIEF DESCRIPTION OF THE DRAWINGS

Various embodiment of the invention will be described in detail by way of example, with reference to accompanying figures, where:

FIG. 1 is a schematical diagram of a Local Area Network;

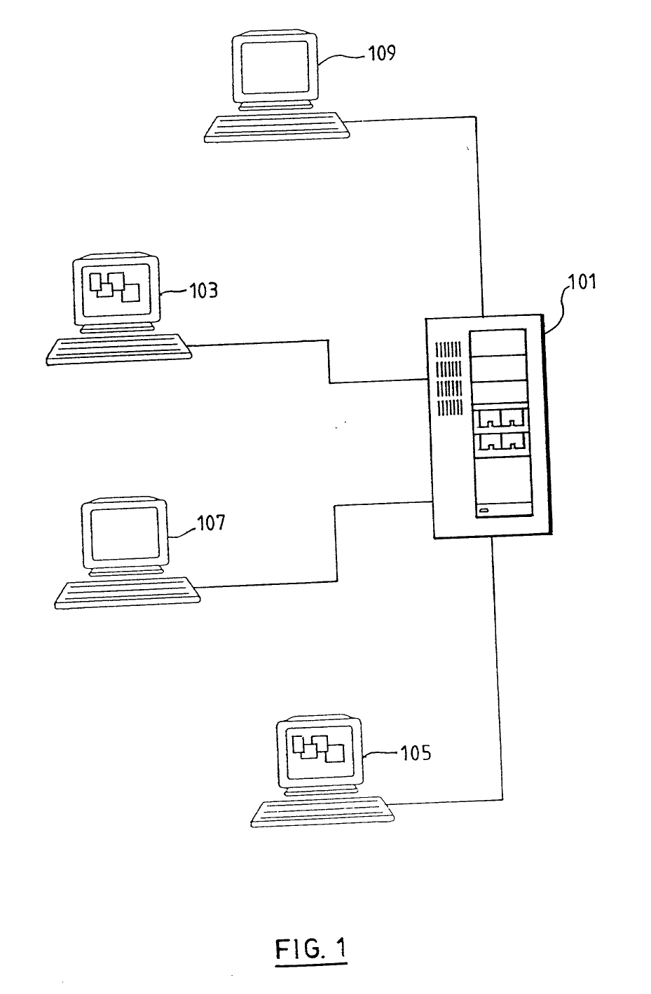

FIG. 2 is a schematical diagram of a Local Area Network using more than one communication protocol according to a preferred embodiment of the present invention;

FIG. 3 is a schematic representation of the method according to a preferred embodiment of the present invention.

### DETAILED DESCRIPTION OF THE PREFERRED EMBODIMENT

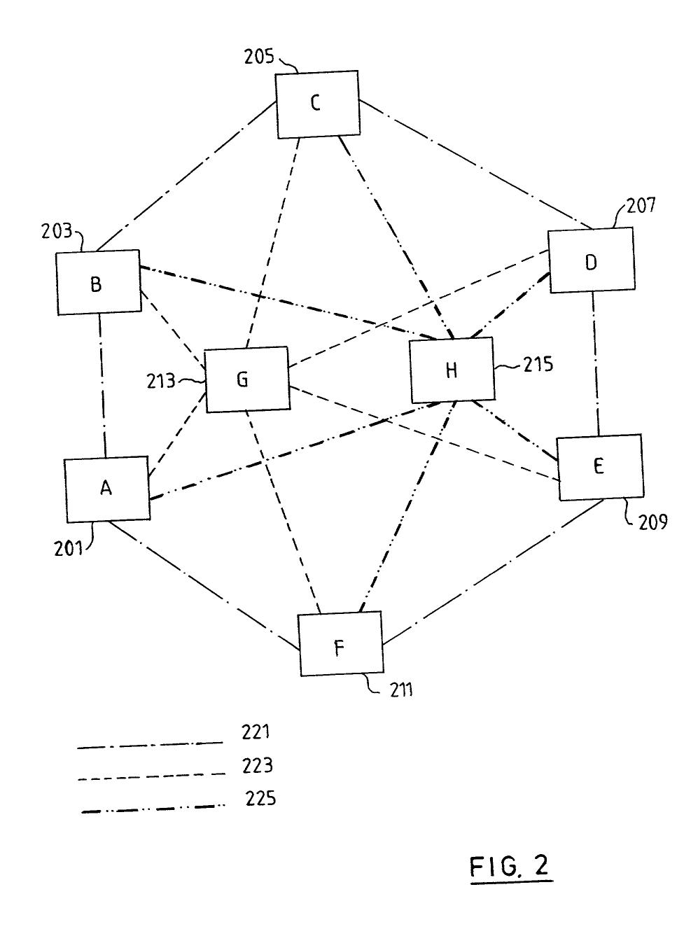

FIG. 2 shows a Local Area Network with six workstations (201-211) connected together. The connection among the workstations is done in three different ways and according to three different communication protocols: a “token ring” architecture as represented by the line 221; passing through the server 213 as represented by the line 223; passing through the server 215 as represented by the line 225. The protocol used by the token ring connection is NetBIOS and the redirector is LAN Server. The server 213 is a communication server for the protocol TCP/IP using the redirector NFS, while the server 215 is the communication server for the protocol IPX and is used by redirector NetWare Server. According to the communication protocol TCP/IP the server 213 is called Domain Name System (DNS) and is necessary for associating the name of a workstation with its address. The server DNS also performs other activities for the TCP/IP, such as giving the authorisation to a client workstation to access a server.

The server 215 is called Service Advertising Protocol (SAP) server and it is needed by the redirector NetWare Server and the protocol IPX for connecting two nodes. Its functions are similar to the functions of DNS.

The token ring architecture does not require any dedicated network server, because the communication among the nodes is ensured by information packets circulating in a ring from one node to the next, until the destination node is reached.

If, for any reason, communication between two nodes of the network fails for a problem caused by one of the redirectors or the related protocol, communication could theoretically be possible using another redirector and possibly through a different path. According to the prior art systems the only possible solution requires the human intervention for re-establishing the connection through a different redirector. This solution, anyway, does not avoid the interruption of service and sometimes the loss of data.

The reasons for which a protocol becomes unavailable can be various. In the case of NFS and its protocol TCP/IP, for example, if the server DNS 213 has an hardware problem, communication between e.g. node 201 and node 207 is no longer possible. The same happens in the case of NetWare if server SAP 215 crashes down. In the case of token ring it is enough that one of the nodes on the ring is physically disconnected that all the other nodes are cut out of the network.

According to the present invention, when the connection between two or more nodes becomes not available a new connection with a different protocol is automatically tried.

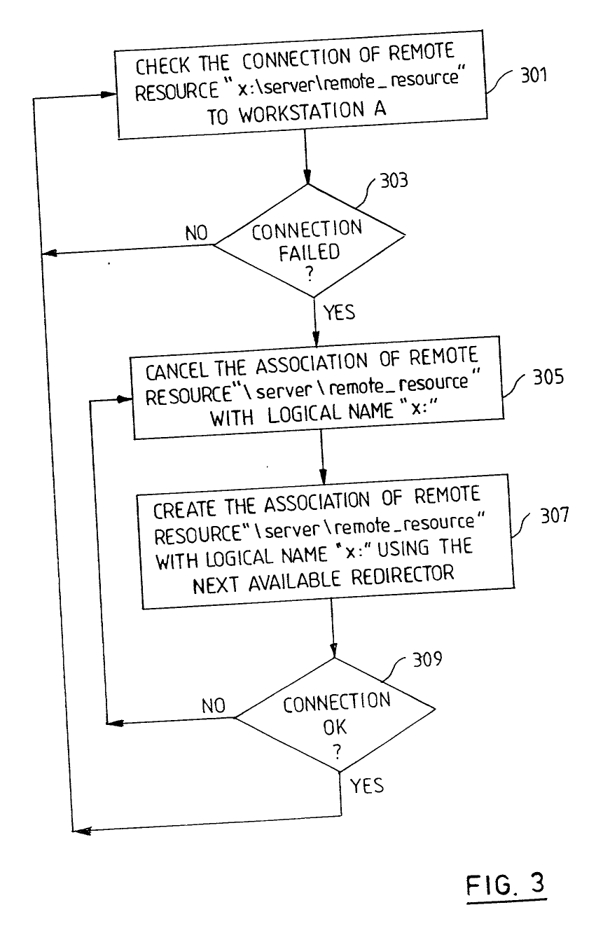

FIG. 3 is a schematical representation of the method according to a preferred embodiment of the present invention. Step 301 detects a failure in the communication between a workstation and a server (in general the communication between two nodes of the network). The connection of the resource “\remote_resource” (e.g. a disk or a partition of a disk), physically resident on the server “\server” (e.g. a file server) is monitored. The remote resource is considered by the workstation A as a local one and identified by the logical name “x:”. Those skilled in the art will appreciate that this monitoring can be done in different ways according to the different situations and requirements. One possible solution is a process which always stays active and performs check of the connection at fixed time intervals. An alternative solution is to perform the check only when an access to a remote resource is requested by a workstation. This can be done, for example by modifying the operating system calls (e.g. the control program function DosOpen for OS/2 operating system).

If disconnection is detected (step 303) the association of the remote resource “\server\remote_resource” with its logical name “x:” is cancelled (step 305). This operation depends on the redirector (and the protocol) used. If, as an example, the redirector is NFS (which uses the TCP/IP protocol) the command performed will be:

“umount x:”

The association between the remote resource “\server\remote_resource” and its logical name “x:” is then re-established using another redirector chosen between the available redirectors (step 307). In our example, if the TCP/IP protocol is not available, we can do the association with the NetWare Server redirector which uses the IPX protocol. The command performed will be:

“map x=remote_resource”

Step 309 checks whether the connection is OK and, in case it fails again the control goes back to step 305 and the same operations are performed using the next available protocol (if any).

In this way the user of workstation A will notice no differences in addressing the remote resource, because the logical name “x:” has not changed.

Those skilled in the art will appreciate that the implementation of the above described method can be done in many different ways depending on different operating systems, the possible requirements and the network configuration. According to the preferred embodiment described with reference to FIG. 2 and FIG. 3, the method has been implemented as a software procedure written in “C” language and running on OS/2 operating system. The redirectors available on the network are Lan Server, using the NetBIOS communication protocol and a token ring network configuration, NetWare Server, using IPX communication protocol and a SAP server, and NFS, using TCP/IP communication protocol and a Domain Name Server.

1. A computer network system connecting a plurality of nodes according to a plurality of available communication protocols, the system comprising:
means for establishing a communication between two nodes using a first of said plurality of communication protocols;
means for detecting a fault in the communication between said two nodes;
means for automatically re-establishing the communication between said two nodes using a second of said plurality of available communication protocols.

2. The computer network of claim 1 wherein said plurality of communication protocol includes TCP/IP.

3. The computer network of claim 1 wherein said plurality of communication protocol includes IPX.

4. The computer network of claim 1 wherein said plurality of communication protocol includes NetBIOS.

5. A method for automatic recovery from a connection fault in a computer network system, the computer network system connecting at least two of a plurality of nodes according to a first of a plurality of available communication protocols, the method comprising the steps of:
monitoring the connection between said two nodes;
upon detection of a fault in the connection between said two nodes re-establishing the communication between said two nodes using a second of said plurality of available protocols.

6. The method of claim 5 wherein the monitoring step comprises the step of checking the connection every fixed time interval.

7. The method of claim 5 wherein the monitoring step comprises the step of checking the connection every time a communication is requested by one of said two nodes.
